(19) United States
(12) Patent Application Publication
(10) Pub. No.: US 2023/0090697 A1
(43) Pub. Date: Mar. 23, 2023

(54) BIOSTIMULANT AGRICULTURAL COMPOSITIONS WITH SUPRAMOLECULAR STRUCTURES AND METHODS OF USE

(71) Applicant: BPS JUST ENERGY TECHNOLOGY, LLC, Argyle, TX (US)

(72) Inventors: Robert A. GEIGER, Argyle, TX (US); David J. COORTS, Argyle, TX (US); Donna Jean SHOTWELL, Argyle, TX (US)

(21) Appl. No.: 17/800,802

(22) PCT Filed: Feb. 19, 2021
(86) PCT No.: PCT/US2021/018786

§ 371 Date: Aug. 18, 2022

Related U.S. Application Data
(60) Provisional application No. 62/980,018, filed on Feb. 21, 2020.

(51) Int. Cl. A01N 25/10; A01N 65/12; A01N 61/00; A01N 65/03; A01P 21/00

(52) U.S. Cl. CPC A01N 25/10; A01N 65/12; A01N 61/00; A01N 65/03; A01P 21/00

(57) ABSTRACT

Compositions with supramolecular structures for agricultural use include a biostimulant, a supramolecular host chemical or a supramolecular guest chemical configured to engage in host-guest chemistry with the biostimulant, and water, are included. Methods of treating a plant to improve nutrient assimilation, water uptake, or vigor, or a combination thereof, include applying an agriculturally effective amount of the composition to the plant are also included.

### BACKGROUND OF THE DISCLOSURE

Over the last few decades there has been growing interest in the agricultural industry to use naturally occurring materials or extractions to create different biostimulants. There has been an increase of utilization of these products to improve crop performance, nutrient efficiency, product quality, and yield. Plant biostimulants include diverse organic and inorganic substances, natural compounds, and/or beneficial microorganisms. Due to their higher cost of production, application has usually been applied to high-value crops, mainly greenhouse crops, fruit trees and vines, open-field vegetable crops, flowers, and ornamentals.

Carbon, hydrogen, oxygen, nitrogen, phosphorus, and sulfur are the primary elements essential to all life. Soils contain these elements as well as other macro and micronutrients that are needed for plant growth, but due to various reasons the needed nutrients can become unavailable and have minimal uptake causing decrease in plant vigor. To overcome these challenges, various growing techniques have been employed, including slow-release fertilizers, acidifiers, different biostimulants, various growth promoting agents, plant growth adjustment agents, or physiological activity promoting agents.

Even though these techniques overcome different and difficult situations there has be a growing concern on increasing nutrient use efficiency while using the minimal amount of active ingredients to minimize environmental pollution and ensure long-term sustainability.

### SUMMARY OF THE DISCLOSURE

In one aspect, the disclosure encompasses an agricultural composition that includes a biostimulant, a supramolecular host or guest chemical configured to engage in host-guest chemistry with the biostimulant, and water. In some embodiments, the biostimulant includes a soluble humic acid, a kelp extract, chitosan, a protein hydrolysate, an amino acid, a beneficial bacteria, a fungi, a terrestrial plant extract, or any combination thereof.

The disclosure also encompasses a method that includes preparing the agricultural composition that includes mixing components of the agricultural composition in the following order: (1) water and (2) the biostimulant to form a mixture, and adding (3) the supramolecular host or guest chemical to mixture to form the agricultural composition.

The disclosure further encompasses a method for treating a plant to improve nutrient assimilation, water uptake, or vigor that includes applying a composition to the plant in an agriculturally effective amount, wherein the composition includes a biostimulant, a supramolecular host or guest chemical configured to engage in host-guest chemistry with the stimulant, and the water.

### BRIEF DESCRIPTION OF THE DRAWINGS

The present disclosure is best understood from the following detailed description when read with the accompanying figures.

FIG. 1 is a graph showing the effect of SymMAX™ supramolecular host water mixture and distilled water on tissue mass in tomatoes in Example 1;

FIG. 2 is a graph showing increased tissue mass in tomatoes when soluble humic acid is used as the biostimulant in Example 1;

FIG. 3 is a graph showing increased tissue mass in tomatoes when kelp extract is used as the biostimulant in Example 1;

FIG. 4 is a graph showing increased tissue mass in tomatoes when terrestrial plant extracts are used as the biostimulant in Example 1;

FIG. 5 is a graph showing increased weight in Zea mays when treated with humic acid in Example 2; and

FIG. 6 is a graph showing increased weight in Zea mays when treated with kelp extract in Example 3.

### DETAILED DESCRIPTION

This disclosure provides compositions and methods that increase nutrient assimilation, water update, and overall plant growth and vigor without losing efficiency. The compositions can be applied using typical industry practices and by any suitable method, such as soil drench, foliar, fertigation, seed treatment, or aerial methods. As used herein, “vigor” of a plant means plant weight (including plant mass, shoot mass, root mass, or a combination thereof), plant height, plant canopy, visual appearance, or any combination of these factors. Thus, increased vigor refers to an increase in any of these factors by a measurable or visible amount when compared to the same plant that has not been treated with the compositions disclosed herein.

The compositions include (1) a biostimulant, (2) a supramolecular host or guest chemical configured to engage in host-guest chemistry with the biostimulant, and (3) water. When components (1)-(3) are mixed together, supramolecular structures are formed that have an enhanced synergy that allow increased nutrition assimilation, water uptake, overall plant growth, plant vigor, or a combination thereof, in a plant to which such compositions is applied. Such supramolecular structures or assemblies may take the form of, e.g., micelles, liposomes, nanostructures, or nanobubbles. Advantageously, the compositions increase plant biomass, total nutrient uptake, total micronutrient uptake, total macronutrient uptake, and/or uptake of one or more of the following elements: nickel, copper, zinc, manganese, iron, molybdenum, boron, calcium, sulfur, phosphorus, magnesium, calcium, potassium, nitrogen, carbon; or a combination of the foregoing.

In various embodiments, the biostimulant is (1) water soluble and (2) has multiple proton exchange sites to accept supramolecular binding. In some embodiments, the biostimulant includes, but is not limited to, one or more of: a soluble humic acid, a kelp extract, chitosan, a protein hydrolysate, an amino acid, beneficial bacteria, fungi, a terrestrial plant extract (TPE), and any combination thereof. Examples of useful biostimulants include one or more of the following:

Protein hydrolysates that are predominantly produced by chemical (e.g., acid and alkaline hydrolysis), thermal and enzymatic hydrolysis of a wide range of both animal wastes and plant biomass. Animal wastes include, for example, animal epithelial or connective tissues such as leather by-products, blood meal, fish by-products, chicken feathers, casein, and any combination thereof. Biomass of plant origin includes, for example, legume seeds, alfalfa hay, corn wet-milling and vegetable by-products, and any combination thereof.

Amino acids can play different roles in plants, such as stress-reducing agents, nitrogen sources and hormone precursors. Exemplary amino acids include glutamate, phenylalanine, cysteine, and glycine alone or in any combination. Amino acid(s) can be applied as seed treatments or as foliar applications, or both.

Beneficial bacterial or plant growth-promoting rhizobacteria (PGPR) are potential agents for the biological control of plant pathogens. They also are believed to be responsible for much of the rhizosphere interaction between plants and soil. Exemplary bacteria for use according to the disclosure include Rhizobia sp., Mycorrhizae sp., Pseudomonas sp., and many species of methylobacterium, and any combination thereof.

Beneficial fungal agents have been used extensively for biocontrol of both plant fungal diseases and insect pests. Any suitable fungal agent that can minimize or plant damage (e.g., root rots, wilts, damping off and bare patches) caused by other pathogenic fungi (e.g., Pythium, Sclerotium, Verticillium) can be used according to the disclosure. Examples of such non-pathogenic (saprophytic) fungal agents include strains of Rhizoctonia, Fusarium, or Trichoderma spp., or combinations thereof.

TPEs are often plant extracts derived from plants commonly subjected to adverse environmental or other abiotic stresses. They generally contain a complex mixture of polysaccharides, micronutrients, and plant growth hormones, and may have a stimulatory effect on plant growth and may enhance plant resistance to abiotic and biotic stresses. TPEs useful here include extracts from guayule, yucca, quillaia, and other assorted ornamentals; and any combination thereof.

The biostimulant is present in any suitable amount, but is generally present in the composition in an amount of about 1 percent to about 90 percent by weight of the composition. In some embodiments, the biostimulant is present in an amount of about 10 percent to about 85 percent, for example 20 percent to about 80 percent, by weight of the composition.

In selecting suitable supramolecular host or guest chemical, which can include one or more of such host or guest chemicals (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with water. Host chemicals may include nanostructures of various elements and compounds, or combinations of the foregoing, which may have a charge, may have magnetic properties, or both. Suitable supramolecular host chemicals include cavitands, cryptands, rotaxanes, catenanes, nanostructures, or any combination thereof.

Cavitands are container-shaped molecules that are capable of engaging in host-guest chemistry with guest molecules of a complementary shape and size. Examples of cavitands include cyclodextrins, calixarenes, pillarrenes, and cucurbiturils. Calixarenes are cyclic oligomers obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH2]₃N or 1,10-diaza-4,7,13,16,21,24-hexaoxabicyclo[8.8.8]hexacosane. Cryptands form complexes with many cations, including NH₄⁺, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another, but cannot be separated unless covalent bond breakage occurs.

Suitable supramolecular guest chemicals include cyanuric acid, water, and melamine, and are preferably selected from cyanuric acid or melamine, or a combination thereof. Another category of guest chemicals includes nanostructures of various elements and compounds, which may have a charge, may have magnetic properties, or both.

The supramolecular host chemical or the supramolecular guest chemical is present in the composition in any suitable amount, but is generally present in the composition in an amount of about 1 percent to about 90 percent by weight of the composition. In certain embodiments, the supramolecular host chemical or supramolecular guest chemical, or host and guest chemical combination, is present in an amount of about 50 percent to about 85 percent by weight of the composition, for example, 60 percent to about 80 percent by weight of the composition.

Any suitable solvent that is compatible with the biostimulant may be used. In one embodiment, a polar solvent may be used, including for example water or any alcohol. Water is used as a preferred solvent for the different components of the composition. Water (or other polar solvent) is present in any suitable amount, but is generally present in the composition in an amount of about 0.1 percent to about 50 percent by weight of the composition. In certain embodiments, the polar solvent, such as water, is present in an amount of about 1 percent to about 45 percent by weight of the composition, for example, 20 percent to about 40 percent by weight of the composition.

The order of addition of the components of the composition can be important to obtain stable supramolecular structures or assemblies in the final mixture. The order of addition is typically: (1) water and (2) biostimulant. Once these two components are fully mixed, the supramolecular host or guest chemical is added to the mixture and allowed to mix thoroughly with the other initial components. The biostimulant compositions of this disclosure, when prepared properly, are stable agricultural compositions that are ready-for-use (either direct application or reconstitution/dilution) for at least 3 months, preferably at least 6 months, and more preferably at least about 12 months or at least about 24 months, when stored out of direct sunlight at room temperature. It should be understood, however, that the shelf-life of the compositions will vary depending on the nature of the biostimulant. For example, bacterial and fungal biostimulants may only be viable for about 3 to 12 months, or even just about 6 to 9 months, and many have specific storage requirements (e.g., refrigeration) that if not carefully met will decrease their viable shelf-life. Kelp Extracts, TPEs, PHs, and other biostimulants normally have a minimum 2-year shelf life.

Additionally, many it may be best to minimize or avoid having any biostimulant, whether before or admixed in a composition herein, be subjected to any freezing/thawing cycles, and thus, storage of biostimulants or the compositions may benefit from or even require environmentally-controlled storage.

These compositions are preferably formed as a concentrate, which is “reconstituted” or otherwise diluted before application to the relevant vegetation (e.g., crops, plants, trees, etc.). The dilution typically occurs on or adjacent the site of application to minimize the need to transport large volumes of the product. The amount or concentration of the present compositions can vary depending on conditions (e.g., soil, humidity, pH, temperature, growing season, amount of daily light, etc.), the concentration and type of components as described herein, as well as the type of plant to which each composition is applied. In some embodiments, an “agriculturally effective amount” means from about 0.1 mL to 50 mL per gallon can be applied to saturate per pot of plant, or from about 20 mL to 100 mL of the solution made, and if the product is to be applied over a field then from about 0.1 qt to 1 qt concentrate of the product with about 5 to 100 gallons of water per acre.

The following examples are illustrative of the compositions and methods discussed above and are not intended to be limiting.

### EXAMPLES

### Example 1

### Effect of Compositions on Tomato Plants

Compositions to be tested were made by combining the different biostimulants at labeled field rates with either SymMAX™ supramolecular host water mixture commercially available from Shotwell Hydrogenics or distilled water at 50 gallons per acre (GPA). The compositions were applied as a root drench at 150 mL/pot.

The biostimulants tested were: (1) acid Quantum H® humic commercially available from Horizon Ag Products, (2) kelp extract (Ascophyllum nodosum) commercially available from Natures Pure Edge, and (3) guayule extract (Parthenium argentatum) commercially available from Beem Biologicals, LLC. The Quantum H® humic acid was tested at 6 gallons per acre, the kelp extract was tested at 2 ounces per acre, and the guayule extract was tested at 8 ounces per acre.

This example was conducted as a 6 replicate, RCBD (randomized control block design) greenhouse bioassay in Quitman, GA. Treatment applications began at “Biologische Bundesanstalt, Bundessortenamt and Chemische Industrie” BBCH stage 16 (6 true leaves emerged) 1-week post-transplant. The trial ran for 21 days with data assessments taken at the end of the trial, one week after final treatment application. The results are provided in Table 1 below.

TABLE 1
RESULTS OF TESTING ON TOMATO PLANTS

| | Root | Shoot | Total | Root | Shoot | Stem |
|---|---|---|---|---|---|---|
| | Mass | Mass | Plant | Length | Length | Diameter |
| Treatment | (g) | (g) | Mass (g) | (in) | (in) | (in) |
| Untreated | 4.2 | 22.9 | 27.1 | 13.4 | 20.8 | 5.1 |
| Control | | | | | | |
| SymMAX ™ | 3.9 | 24.3 | 28.3 | 11.9 | 20.1 | 4.5 |
| supramolecular | | | | | | |
| host water | | | | | | |
| mixture at | | | | | | |
| 150 mL | | | | | | |
| Humic acid at | 2.4 | 8.8 | 11.3 | 6.1 | 14.7 | 3.7 |
| 6 gallons/acre | | | | | | |
| in water | | | | | | |
| Humic acid at | 5.7 | 26.9 | 32.8 | 11.1 | 22.8 | 4.5 |
| 6 gallons/ | | | | | | |
| acre + | | | | | | |
| SymMAX ™ | | | | | | |
| supramolecular | | | | | | |
| host water | | | | | | |
| mixture | | | | | | |
| Kelp extract at | 6.0 | 23.6 | 29.6 | 10.5 | 20.5 | 4.1 |
| 2 ounces/acre | | | | | | |
| in water | | | | | | |
| Kelp extract at | 5.3 | 31.7 | 37.1 | 9.9 | 24.9 | 4.6 |
| 2 ounces/acre + | | | | | | |
| SymMAX ™ | | | | | | |
| supramolecular | | | | | | |
| host water | | | | | | |
| mixture | | | | | | |
| Guayule | 6.8 | 33.6 | 40.4 | 11.2 | 22.7 | 4.9 |
| extract at | | | | | | |
| 8 ounces/acre | | | | | | |
| in water | | | | | | |
| Guayule | 11.3 | 36.5 | 47.8 | 10.9 | 20.6 | 4.6 |
| extract at | | | | | | |
| 8 ounces/acre + | | | | | | |
| SymMAX ™ | | | | | | |
| supramolecular | | | | | | |
| host water | | | | | | |
| mixture | | | | | | |

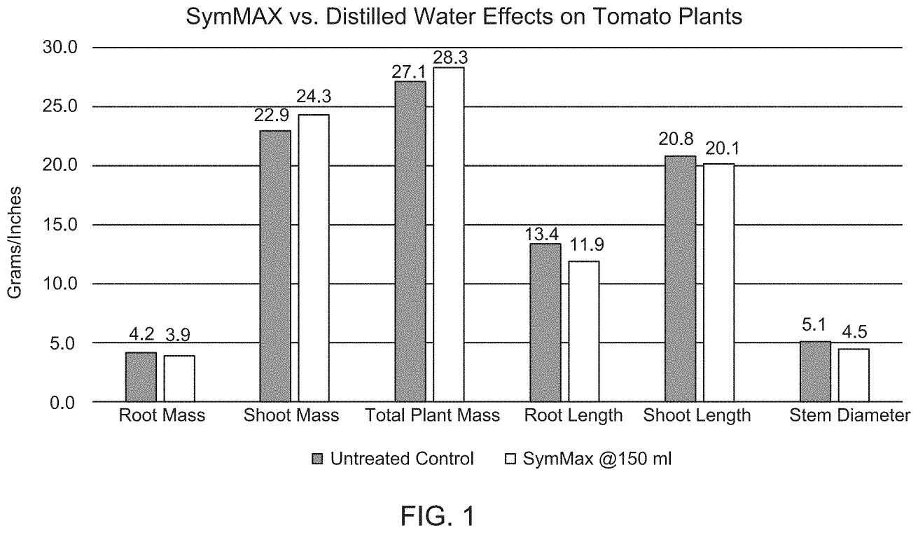

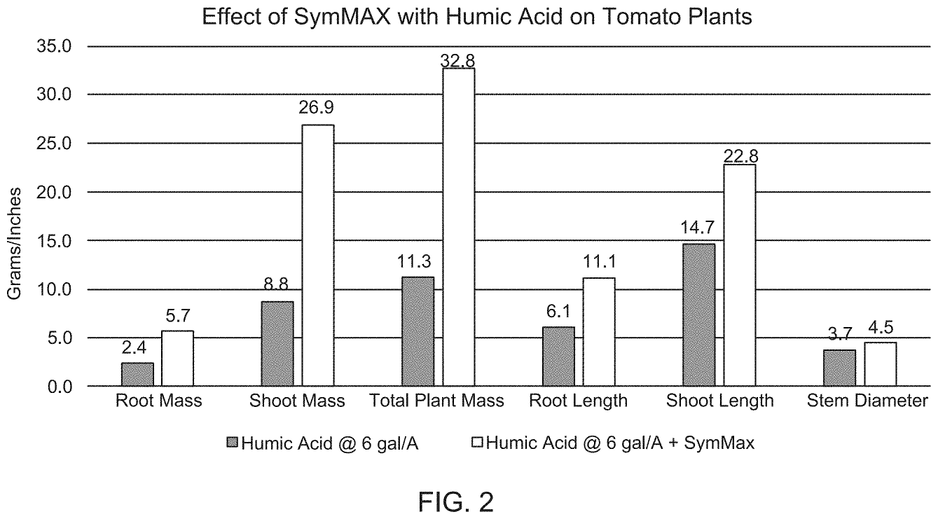

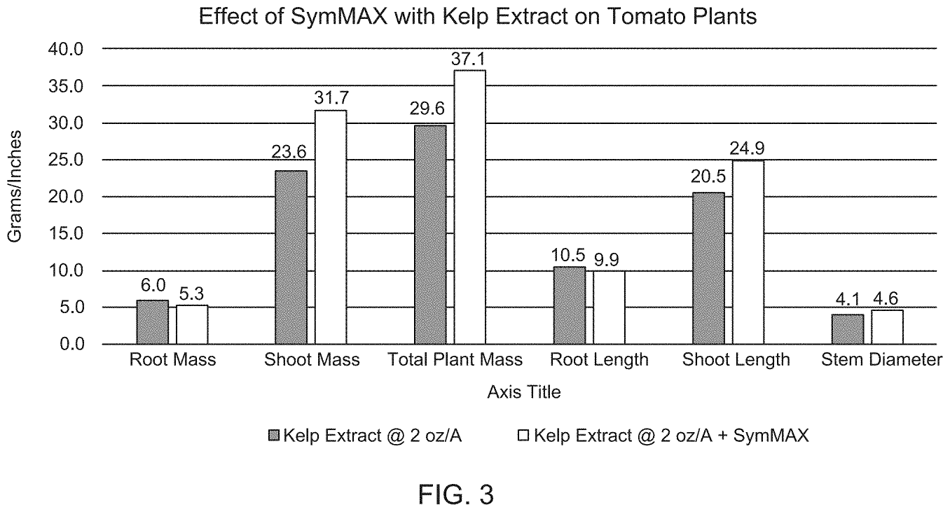

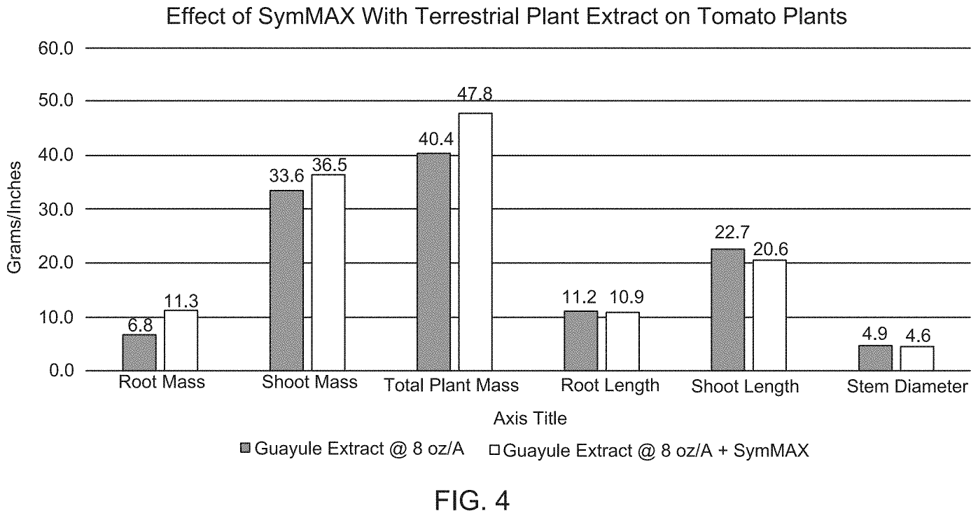

FIGS. 1-4 provide the results of the testing on tomato plants. The data presented is the means of the 6 replicates as recorded by the researcher and analyzed using ANOVA statistical analysis. As can be seen from FIGS. 2-4, treatments that combined a biostimulant with SymMAX™ supramolecular host water mixture increased tissue mass and plant vigor in tomatoes compared to treatments without SymMAX™ supramolecular host water mixture.

### Example 2

### Effect of Humic Acid Compositions on Zea Mays

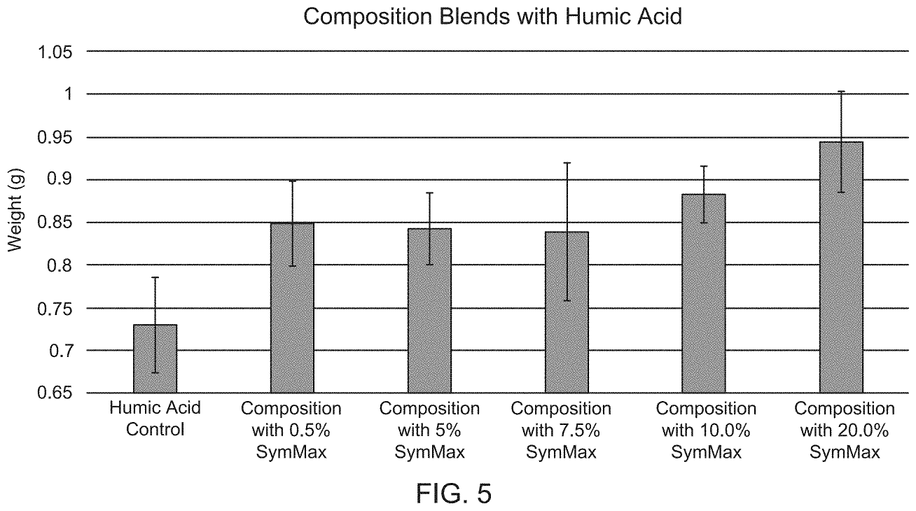

This example was completed to understand the symbiosis on the effect of supramolecular chemistry with a common biostimulant, humic acid. For this example, a sandy loam soil was used, sourced from a local garden supplier. One inch (1″) diameter potting cones were utilized in the experiment and sourced from Stuewe and Sons (SC10) and were filled with 165 grams of soil with a cotton ball on the bottom of each cone to keep the soil from leaching. Each pot received 10 mL of water prior to planting. One hundred (100) ppm of nitrogen was applied to each pot by making a 23.05% solution of 20-12-20 Peters Professional® General purpose fertilizer and adding 0.358 grams of fertilizer mix to each pot. The treatments were applied at 8 lb/acre of potassium humate that was procured from LignoTech Argo under the name BorreGRO® HA-1. This treatment was viewed as the control. The supramolecular compositions were screened at the same rates of humic acid, but with 0.05, 5, 7.5, 10, and 20% of supramolecular chemistry compared to the rate of potassium humate (i.e. 0.05% would be 0.004 lb/acre of supramolecular chemistry). The supramolecular chemistry utilized in this example was SymMAX™ supramolecular host water mixture sourced from Shotwell Hydrogenics. Zea mays was allowed to grow until emergence occurred and harvested to determine total wet weight. FIG. 5 shows the comparison of compositions with different percentages of supramolecular host chemistry while keeping the rate of humic acid the same. Table 2 provides the results. Unexpectedly, a positive increase in total wet biomass for all composition blends was observed with the highest increase being 29%. This large increase during the seedling development stages provided the seedling with increased total plant vigor and root development.

TABLE 2
RESULTS OF HUMIC ACID TEST

| Treatment | Wet Weight (g) |
|---|---|
| Humic Acid Control | 0.730 |
| Composition with 0.5% SymMax ™ | 0.848 |
| Composition with 5% SymMax ™ | 0.842 |
| Composition with 7.5% SymMax ™ | 0.838 |
| Composition with 10.0% SymMax ™ | 0.882 |
| Composition with 20.0% SymMax ™ | 0.943 |

### Example 3

### Effect of Kelp Extract Compositions on Zea Mays

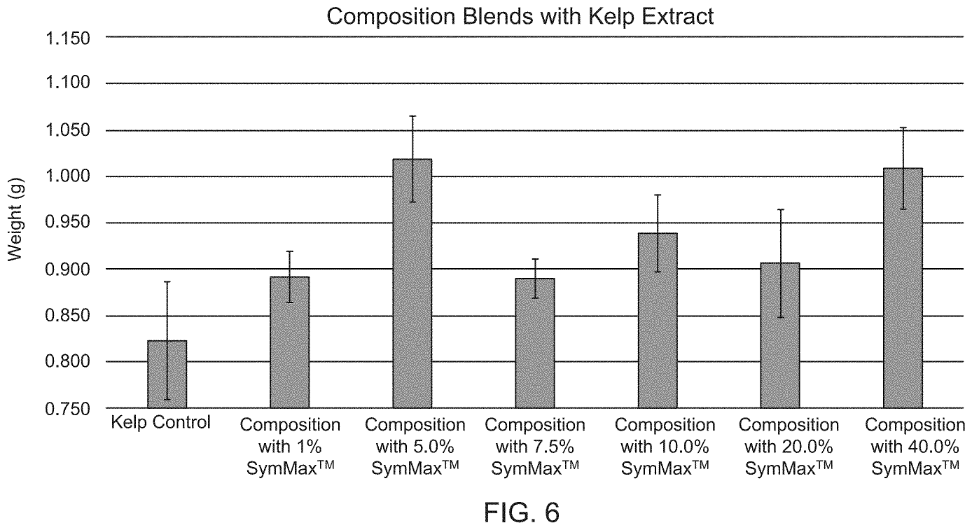

This example was completed to understand the symbiosis on the effect of supramolecular chemistry with another common biostimulant, kelp extract. For this example, a sandy loam soil was used, sourced from a local garden supplier. One inch (1″) diameter potting cones were utilized in the experiment and sourced from Stuewe and Sons (SC10) and were filled with 165 grams of soil with a cotton ball on the bottom of each cone to keep the soil from leaching. Each pot received 10 mL of water prior to planting. One hundred (100 ppm) of nitrogen was applied to each pot by making a 23.05% solution of 20-12-20 Peters Professional® General purpose fertilizer and adding 0.358 grams of fertilizer mix to each pot. The treatments were applied at 1.6 oz/acre of kelp extract (0.0066 ppm to the soil) that was procured from UPL under the name GA-142 Seaweed Filtrate. This treatment was the control. The supramolecular compositions were screened at the same rates of kelp extract with 1, 5, 7.5, 10, 20, and 40% of supramolecular chemistry compared to the rate of kelp extract (i.e. 1% would be 0.016 oz/acre of supramolecular chemistry). The supramolecular chemistry utilized in this example was SymMAX™ supramolecular host water mixture sourced from Shotwell Hydrogenics. Zea mays was allowed to grow until emergence occurred and harvested to determine total wet weight. FIG. 6 shows the comparison of compositions with different percentages of supramolecular host chemistry while keeping the rate of kelp extract the same. Table 3 provides the results. Surprisingly, a suspension bridge response with all the composition was observed with an increase in total wet biomass for all composition blends with the highest increase being 24%. This large increase during the seedling development stages provided the seedling with increased total plant vigor and root development.

TABLE 3
RESULTS OF KELP EXTRACT TEST

| Treatment | Wet Weight (g) |
|---|---|
| Kelp Control | 0.823 |
| Composition with 1% SymMax ™ | 0.892 |
| Composition with 5.0% SymMax ™ | 1.018 |
| Composition with 7.5% SymMax ™ | 0.890 |
| Composition with 10.0% SymMax ™ | 0.938 |
| Composition with 20.0% SymMax ™ | 0.907 |

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

1. An agricultural composition comprising:
a biostimulant;
a supramolecular host or guest chemical configured to engage in host-guest chemistry with the biostimulant; and
water.

2. The agricultural composition of claim 1, wherein the biostimulant comprises a soluble humic acid, a kelp extract, chitosan, a protein hydrolysate, an amino acid, a beneficial bacteria, a fungi, a terrestrial plant extract, or any combination thereof.

3. The agricultural composition of claim 2, wherein the biostimulant comprises a terrestrial plant extract, and the terrestrial plant extract comprises a guayule extract.

4. The agricultural composition of claim 1, wherein the biostimulant is present in an amount of about 1 percent to about 90 percent by weight of the composition.

5. The agricultural composition of claim 1, wherein the supramolecular host chemical or supramolecular guest chemical is present in an amount of about 1 percent to about 90 percent by weight of the composition.

6. The agricultural composition of claim 1, wherein the supramolecular host chemical is present and comprises a cavitand, a cryptand, a rotaxane, a catenane, a nanostructure, or any combination thereof, or the supramolecular guest chemical is present and comprises cyanuric acid, melamine, or any combination thereof, or both a supramolecular host and guest chemical are present.

7. The agricultural composition of claim 1, wherein the supramolecular host chemical is present and comprising a nanostructure having a charge, magnetic properties, or both.

8. The agricultural composition of claim 1, wherein the water is present in an amount of 0.1 percent to about 50 percent by weight of the composition.

9. A method of preparing the agricultural composition of claim 1, comprising:
mixing components of the agricultural composition in the following order:
(1) the water, and
(2) the biostimulant,
to form a mixture; and
adding (3) the supramolecular host or guest chemical to the mixture to form the agricultural composition.

10. A method of treating a plant to improve nutrient assimilation, water uptake, or vigor, comprising:
applying a composition to the plant in an agriculturally effective amount, the composition comprising:
a biostimulant;
a supramolecular host or guest chemical configured to engage in host-guest chemistry with the biostimulant; and
water.

11. The method of claim 10, wherein the composition is applied by soil drench, foliar, fertigation, seed treatment, or aerial methods, or a combination thereof.

12. The method of claim 10, wherein the biostimulant is selected to comprise a soluble humic acid, a kelp extract, chitosan, a protein hydrolysate, an amino acid, a beneficial bacteria, a fungi, a terrestrial plant extract, or any combination thereof.

13. The method of claim 12, wherein the biostimulant is selected to comprise a soluble humic acid, a kelp extract, a terrestrial plant extract, or any combination thereof.

14. The method of claim 13, wherein the terrestrial plant extract is present and selected to comprise guayule extract.

15. The method of claim 10, wherein the biostimulant is present in an amount of about 1 percent to about 90 percent by weight of the composition.

16. The method of claim 10, wherein the supramolecular host chemical or supramolecular guest chemical is present in an amount of about 1 percent to about 90 percent by weight of the composition.

17. The method of claim 10, wherein the supramolecular host chemical is present and comprises a cavitand, a cryptand, a rotaxane, a catenane, a nanostructure, or any combination thereof, or the supramolecular guest chemical is present and comprises cyanuric acid, melamine, or any combination thereof, or both a supramolecular host and guest chemical are present.

18. The method of claim 10, wherein the supramolecular host chemical is present and comprises a nanostructure having a charge, magnetic properties, or both.

19. The method of claim 10, which further comprises increasing a plant biomass in the plant compared to a plant that did not receive the agriculturally effective amount of the composition.

20. The method of claim 10, wherein the plant biomass comprises root mass, shoot mass, total plant mass, root length, shoot length, stem diameter, wet weight, or any combination thereof.

21. The method of claim 10, further comprising increasing a nutrient uptake in the plant compared to a plant that did not receive the agriculturally effective amount of the composition.

22. The method of claim 10, wherein there is an increased nutrient uptake of nickel, copper, zinc, manganese, iron, molybdenum, boron, calcium, sulfur, phosphorus, magnesium, calcium, potassium, nitrogen, carbon, or a combination thereof.
